(19) United States
(12) Patent Application Publication
(10) Pub. No.: US 2010/0302394 A1
(43) Pub. Date: Dec. 2, 2010

(54) BLINKED EYE ARTIFACT REMOVAL FOR A DIGITAL IMAGING DEVICE

(76) Inventors: Phanish Hanagal Srinivasa Rao, Bangalore (IN); Narendran Melethil Rajan, Bangalore (IN); Sherin Sasidharan, Bangalore (IN); Abhishek Subashchand Ranka, Bangalore (IN)

Correspondence Address: TEXAS INSTRUMENTS INCORPORATED, P O BOX 655474, M/S 3999, DALLAS, TX, 75265, US

(21) Appl. No.: 12/473,280

(22) Filed: May 28, 2009

(51) Int. Cl. H04N 5/228; G06K 9/40

(52) U.S. Cl. 348/222.1; 382/254

(57) ABSTRACT

A method for removing a blinked eye artifact from an image captured by a digital imaging device includes storing multiple images of a subject captured during a burst shot mode of a digital imaging device. The method also includes identifying a presence of a blinked eye artifact on a selected image of the subject upon a receipt of the selected image. The method further includes modifying the blinked eye artifact on the selected image with an open eye image from the multiple images of the subject captured during the burst shot mode.

### FIELD OF TECHNOLOGY

Embodiments of the disclosure generally relate to the field of electronics, and more particularly to a digital imaging device.

### BACKGROUND

A blinked eye artifact removal refers to removal of a blinked eye or closed eye artifact from an image captured by a digital camera. The blinked eye artifact may be proactively prevented from occurring by delaying a shot taken by the digital camera for a duration when an eye of a subject (e.g., a person, an animal, any living organism with eyes, etc.) whose picture is about to be taken is closed. However, the preventive measure may not work effectively in case of multiple subjects since it is difficult to synchronize eye movements of the multiple subjects.

Alternatively, the blinked eye artifact may be removed from the captured image subsequently by replacing or modifying the blinked eye artifact with an open eye image from a library or a database of open eyes collected from a large population size. However, the above scheme may be too complex to implement, and the end result may not be satisfactory since there may be many differences between facial features (e.g., eye color, skin color, facial complexion, shapes of facial features surrounding the blinked eye, etc.) associated with the blinked eye artifact and the open eye image replacing the blinked eye artifact.

### SUMMARY

This Summary is provided to comply with 37 C.F.R. §1.73, requiring a summary of the invention briefly indicating the nature and substance of the invention. It is submitted with the understanding that it will not be used to interpret or limit the scope or meaning of the claims.

A method and system of a blinked eye artifact removal for a digital imaging device is disclosed. In one aspect, a method for removing a blinked eye artifact from an image captured by a digital imaging device includes detecting and storing an open eye image of a subject using preview frames of the subject prior to a receipt of a captured image of the subject. The method further includes identifying a presence of a blinked eye artifact on the captured image of the subject upon the receipt of the captured image and modifying the blinked eye artifact on the captured image with the open eye image of the subject.

In another aspect, a method for removing a blinked eye artifact from an image captured by a digital imaging device includes storing multiple images of a subject captured during a burst shot mode of the digital imaging device and identifying a presence of the blinked eye artifact on a selected image of the subject upon a receipt of the selected image. Further, the method includes modifying the blinked eye artifact on the selected image with an open eye image from the multiple images of the subject captured during the burst shot mode.

In yet another aspect, a blinked eye artifact removal system for a digital imaging device includes a detect module for determining a presence of a blinked eye artifact on a captured image of a plurality of subjects upon a receipt of the captured image. Further, the blinked eye artifact removal system includes a capture module for capturing respective open eye images of the plurality of subjects prior to the receipt of the captured image, and a modifier module for modifying the blinked eye artifact on the captured image using a corresponding one of the open eye images. The blinked eye artifact removal system also includes a database for storing the open eye images of the plurality of subjects.

Other features of the embodiments will be apparent from the accompanying drawings and from the detailed description that follows.

### BRIEF DESCRIPTION OF THE VIEWS OF DRAWINGS

FIG. 1 illustrates a block diagram of an exemplary digital imaging device with a blinked eye artifact removal system, according to one embodiment.

FIG. 2 illustrates a flow chart of an exemplary method for removing a blinked eye artifact from a captured image during a single shot mode of the digital imaging device of FIG. 1.

FIG. 3 illustrates a flow chart of another exemplary method for removing a blinked eye artifact from a captured image during a burst shot mode of the digital imaging device of FIG. 1.

FIG. 4 illustrates a process diagram of an exemplary method for removing a blinked eye artifact from a captured image, according to one embodiment.

FIG. 5 illustrates a process diagram of another exemplary method for removing a blinked eye artifact from a captured image, according to one embodiment.

The drawings described herein are for illustration purposes only and are not intended to limit the scope of the present disclosure in any way.

### DETAILED DESCRIPTION

A method and system of a blinked eye artifact removal for a digital imaging device is disclosed. The following description is merely exemplary in nature and is not intended to limit the present disclosure, applications, or uses. It should be understood that throughout the drawings, corresponding reference numerals indicate like or corresponding parts and features.

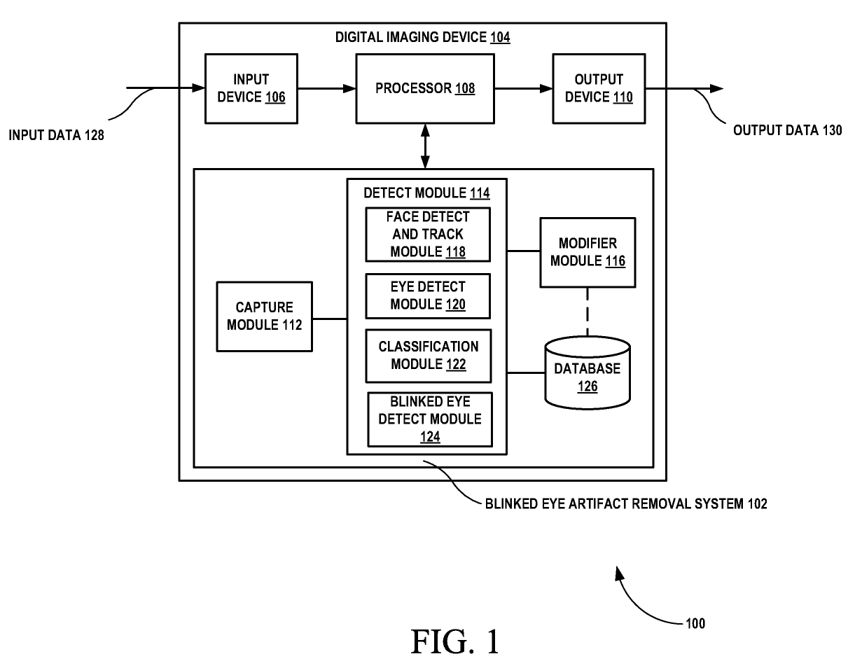

FIG. 1 illustrates a block diagram 100 of an exemplary digital imaging device 104 (e.g., a digital camera, a mobile device, a mobile phone with a digital camera, a camcorder with a digital camera, etc.) with a blinked eye artifact removal system 102, according to one embodiment. The digital imaging device 104 includes the blinked eye artifact removal system 102, an input device 106, a processor 108 and an output device 110. The blinked eye artifact removal system 102, which is coupled to the processor 108, includes a capture module 112, a detect module 114, a modifier module 116 and a database 126.

The detect module 114 includes a face detect and track module 118, an eye detect module 120, a classification module 122 and a blinked eye detect module 124. Further, the detect module 114 is coupled to the database 126. The blinked eye artifact removal system 102 may be a software component, a hardware component or a combination of both.

In operation, during a process of capturing an image, the input device 106 of the digital imaging device 104 receives input data 128. The input data 128 includes images from preview frames, which are also known as view-finder frames, captured image(s) with or without blinked eye artifacts, and so on. The input data 128 is then processed in the processor 108 to remove any blinked eye artifacts on the captured image. In one embodiment, the blinked eye artifacts on the captured image are removed using the blinked eye artifact removal system 102. The processed image is then forwarded to the output device 110 to produce output data 130 (e.g., the captured image with the blinked eye artifacts removed).

In accordance with the above mentioned embodiments, the capture module 112 captures respective open eye images of a plurality of subjects prior to a receipt of a captured image. Further, the detect module 114 determines a presence of a blinked eye artifact on the captured image of the plurality of subjects upon a receipt of the captured image. In one exemplary implementation, the face detect and track module 118 detects faces of the plurality of subjects. Further, the eye detect module 120 detects respective eyes from the faces of the plurality of subjects. Furthermore, the classification module 122 classifies a degree of closing (e.g., open, partially open, closed) for each one of eyes of the plurality of subjects. In one embodiment, the open eye images of the plurality of subjects are stored in the database 126. Then, the blinked eye detect module 124 detects at least one blinked eye artifact from the eyes of the plurality of subjects. The modifier module 116 then modifies the blinked eye artifact on the captured image using a corresponding one of the open eye images stored in the database 126.

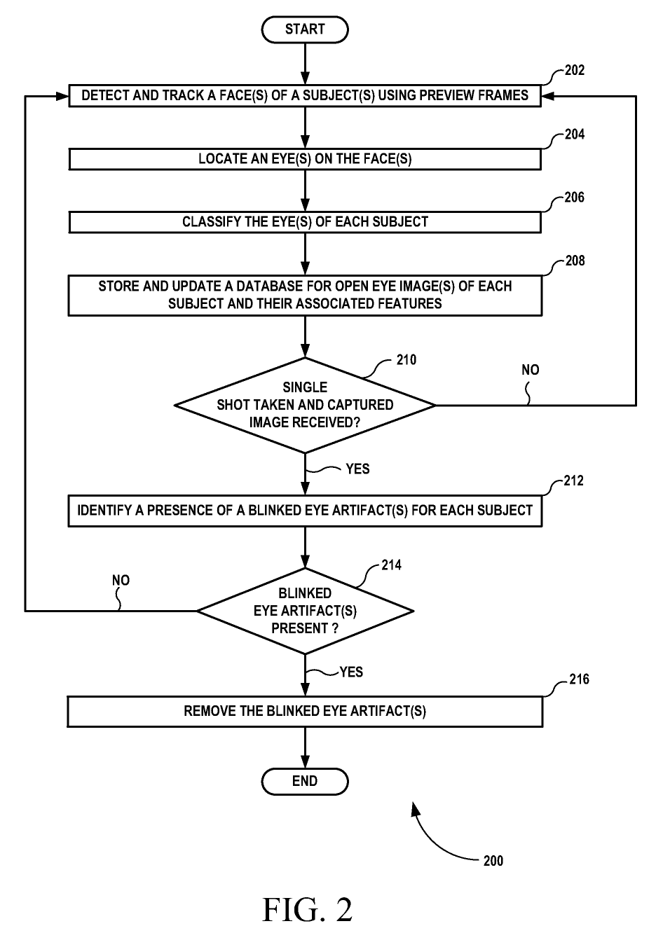

FIG. 2 illustrates a flow chart of an exemplary method 200 for removing a blinked eye artifact from a captured image during a single shot mode of the digital imaging device 104 of FIG. 1. In step 202, a face(s) of a subject(s) is detected and tracked using preview frames prior to a receipt of the captured image of the subject(s) using the face detect and track module 118. In one example embodiment, the receipt of the captured image may be performed when a picture of the subject(s) is taken. In step 204, an eye(s) on the face(s) of the subject(s) is located using the eye detect module 120. In step 206, the eye(s) of each subject is classified as open, partially open, or closed based on the degree of closing of the eye(s) using the classification module 122.

In step 208, an open eye image(s) of each subject with spatial information of the eye(s) and the associated features (e.g., eyebrow, eye lash line, etc.) are stored and updated to the database 126. In one embodiment, the open eye image(s) for each subject is stored to the database 126 of the digital imaging device 104 if the degree of closing of the eye(s) is greater than a first threshold value (e.g., 0.5 cm, 1 cm, etc.). Further, the open eye image(s) in the database 126 is updated with the latest open eye image(s) by processing each preview frame prior to the receipt of the captured image.

In step 210, it is determined whether a single shot is taken and the captured image is received. If the condition is not satisfied, the process is repeated from step 302. Otherwise, a presence of a blinked eye artifact(s) on the captured image of the subject(s) is identified in step 212 based on the database formed during steps 202 through 206. In step 214, it is determined whether the blinked eye artifact(s) on the captured image is present. If the condition is met, then the blinked eye artifact(s) is removed in step 216 using the open eye image(s) from the database 126, thus completing the method 200. Otherwise, the process is repeated from step 302.

In one exemplary implementation, the blinked eye artifact(s) is removed by blending the open eye image(s) to the captured image using the associated features. In one embodiment, the blinked eye artifact(s) on the captured image is removed using an interpolation technique if a resolution of the open eye image(s) is different from the resolution of the blinked eye artifact(s) on the captured image. Typically, the preview frames are of lower resolution compared to that of captured images, hence the interpolation technique may be used. The interpolation technique enables conversion of low resolution open eye image(s) to high resolution open eye image(s). One such interpolation technique used to remove the blinked eye artifact(s) may include an autoregression based interpolation method which helps perform dual geometry symmetry between coarse and fine scales and thus obtain better visual quality.

In another embodiment, the blinked eye artifact(s) on the captured image is removed using a model-based reconstruction technique. The model-based reconstruction technique enables interpolation of missing regions (e.g., of arbitrary size and of random but known location) in image sequences. In yet another embodiment, the blinked eye artifact(s) on the captured image is removed using a super resolution technique. The super resolution technique includes a set of methods for enhancing an image resolution in the digital imaging device 104. The super resolution technique uses information from multiple images to create one upsized image. Since the interpolation technique, model-based reconstruction technique and super resolution technique are well known to one skilled in the art, the detailed explanation is thereof omitted.

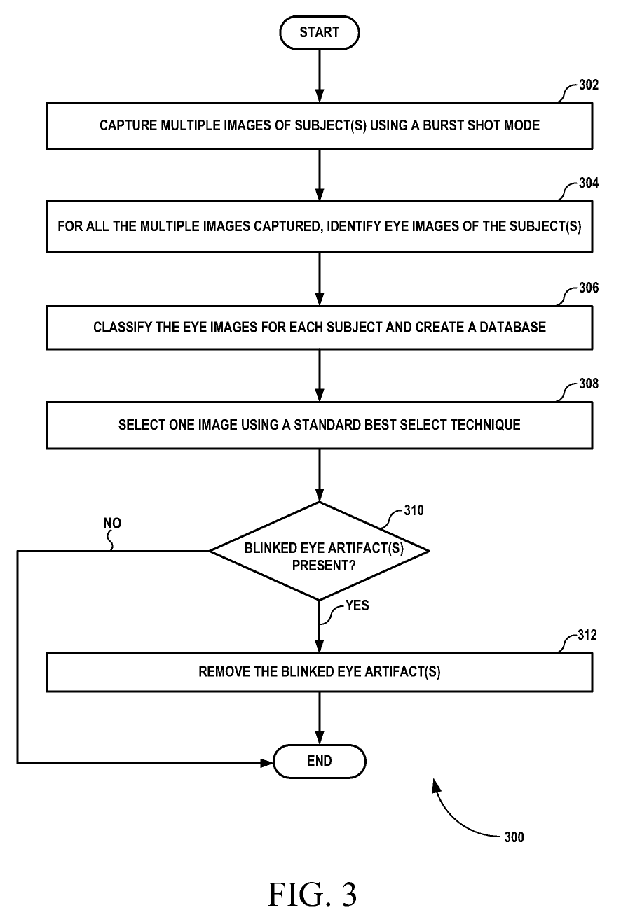

FIG. 3 illustrates a flow chart of another exemplary method 300 for removing a blinked eye artifact(s) from a captured image during a burst shot mode of the digital imaging device 104 of FIG. 1. In step 302, multiple images of a subject(s) are captured using the burst shot mode of the digital imaging device 104. In step 304, eye images of the subject(s) are identified for all the multiple images captured by the digital imaging device 104.

In step 306, the eye images of each subject are classified and a database (e.g., the database 126 of FIG. 1) is created. In one embodiment, the eye images of each subject are classified using metadata based on a degree of closing for each eye image (e.g., open, partially open, closed, etc.). Further, the eye images of each subject are stored to the database 126.

In step 308, an image of the subject(s) is selected from the multiple images using a standard best select technique. In step 310, it is determined whether a blinked eye artifact(s) on the selected image is present or not. If the artifact is found, the blinked eye artifact(s) on the selected image is removed in step 312 using one or more respective open eye images from the database 126. Otherwise, the process is terminated.

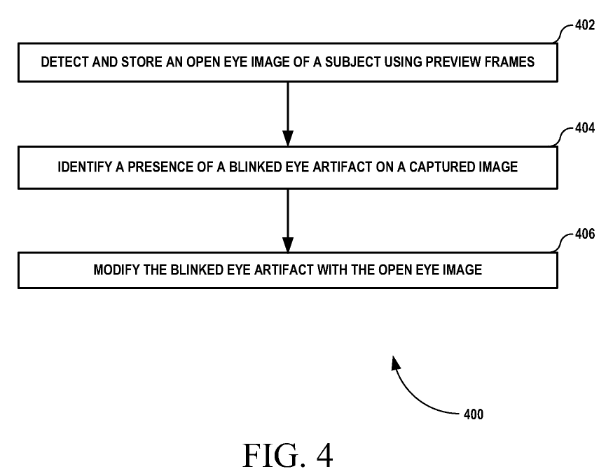

FIG. 4 illustrates a process diagram 400 of an exemplary method for removing a blinked eye artifact from a captured image. In operation 402, an open eye image of a subject is detected and stored using preview frames of the subject prior to a receipt of the captured image. In one embodiment, the open eye image of the subject is detected by detecting a face of the subject, locating an eye on the face of the subject and determining a degree of closing of the eye (e.g., open, partially open, closed, etc.). In this embodiment, the open eye image for the subject is stored to a database of a digital imaging device if the degree of closing of the eye is greater than a first threshold value (e.g., which may translate to the full visibility of the subject's eyeball).

In addition, associated features of the open eye image are stored to the database. Further, the open eye image stored in the database is updated with the latest open eye image by processing each frame of the preview frames prior to the receipt of the captured image. Hence, the method is adaptive to the movement of faces of the subjects. In operation 404, a presence of a blinked eye artifact on the captured image of the subject is identified upon the receipt of the captured image. In one embodiment, the presence of the blinked eye artifact on the captured image is identified by measuring a degree of closing for each eye on the captured image. In operation 406, the blinked eye artifact on the captured image is modified with the open eye image. The blinked eye artifact is modified by blending the open eye image to the captured image using the associated features. In one embodiment, the steps described in FIG. 4 may be performed using the digital imaging device 104 illustrated in FIG. 1.

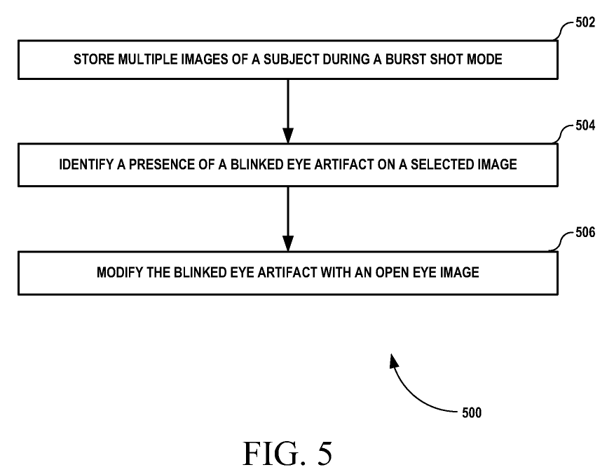

FIG. 5 illustrates a process diagram 500 of another exemplary method for removing a blinked eye artifact from a captured image, according to one embodiment. In operation 502, multiple images of a subject captured during a burst shot mode of a digital imaging device are stored. In one embodiment, eye images of the subject are captured based on the multiples images of the subject. Further, the eye images of the subject are classified using metadata based on a degree of closing for each eye image. In addition, the eye images of the subject are stored to a database.

In operation 504, a presence of a blinked eye artifact on a selected image of the subject is identified upon a receipt of the selected image. In one embodiment, the selected image is generated using a standard best select technique, which selects the best image among shots taken during the burst mode based on preconfigured criteria. In 506, the blinked eye artifact on the selected image is modified with an open eye image from the multiple images of the subject captured during the burst shot mode. In one embodiment, the steps described in FIG. 5 may be performed using the digital imaging device 104 illustrated in FIG. 1.

Although the present embodiments have been described with reference to specific example embodiments, it will be evident that various modifications and changes may be made to these embodiments without departing from the broader spirit and scope of the various embodiments. For example, the various devices, modules, analyzers, generators, etc. described herein may be enabled and operated using hardware circuitry (e.g., complementary metal oxide semiconductor (CMOS) based logic circuitry), firmware, software and/or any combination of hardware, firmware, and/or software (e.g., embodied in a machine readable medium). For example, the various electrical structure and methods may be embodied using transistors, logic gates, and electrical circuits (e.g., application specific integrated circuit (ASIC)).

What is claimed is:

1. A method for removing a blinked eye artifact from an image captured by a digital imaging device, comprising:
detecting and storing an open eye image of a subject using preview frames of the subject prior to a receipt of a captured image of the subject;
identifying a presence of a blinked eye artifact on the captured image of the subject upon the receipt of the captured image; and
modifying the blinked eye artifact on the captured image with the open eye image.

2. The method of claim 1, wherein detecting the open eye image of the subject comprises:
detecting a face of the subject;
locating an eye on the face of the subject; and
determining a degree of closing of the eye.

3. The method of claim 2, wherein storing the open eye image for the subject comprises:
storing the open eye image to a database of the digital imaging device if the degree of closing of the eye is greater than a first threshold value.

4. The method of claim 3, wherein determining the degree of closing of the eye comprises determining the eye to be one of open, partially open, and closed.

5. The method of claim 3, wherein the storing the open eye image further comprises storing associated features of the open eye image to the database.

6. The method of claim 3 further comprising updating the open eye image in the database with a latest open eye image by processing each frame of the preview frames prior to the receipt of the captured image.

7. The method of claim 1, wherein identifying the presence of the blinked eye artifact on the captured image comprises measuring a degree of closing for each eye on the captured image.

8. The method of claim 1, wherein modifying the blinked eye artifact on the captured image comprises modifying the blinked eye artifact using an interpolation technique if a resolution of the open eye image is lower than a resolution of the blinked eye artifact on the captured image.

9. The method of claim 1, wherein modifying the blinked eye artifact on the captured image comprises modifying the blinked eye artifact using a model-based reconstruction technique.

10. The method of claim 1, wherein modifying the blinked eye artifact on the captured image comprises modifying the blinked eye artifact using a super resolution technique.

11. The method of claim 5, further comprising blending the open eye image to the captured image using the associated features.

12. A method for removing a blinked eye artifact from an image captured by a digital imaging device, comprising:
storing multiple images of a subject captured during a burst shot mode of a digital imaging device;
identifying a presence of a blinked eye artifact on a selected image of the subject upon a receipt of the selected image; and
modifying the blinked eye artifact on the selected image with an open eye image from the multiple images of the subject captured during the burst shot mode.

13. The method of claim 12, wherein the storing the multiple images of the subject comprises:
capturing eye images of the subject based on the multiple images of the subject;
classifying the eye images using metadata based on a degree of closing for each eye image; and
storing the eye images to a database.

14. The method of claim 12, wherein the selected image is generated using a standard best select technique.

15. A blinked eye artifact removal system for a digital imaging device, comprising:
a detect module for determining a presence of a blinked eye artifact on a captured image of a plurality of subjects upon a receipt of the captured image;
a capture module for capturing respective open eye images of the plurality of subjects prior to the receipt of the captured image; and
a modifier module for modifying the blinked eye artifact on the captured image using a corresponding one of the open eye images.

16. The system of claim 15, wherein the digital imaging device comprises a digital camera.

17. The system of claim 15, wherein the digital imaging device comprises a mobile device.

18. The system of claim 15, wherein the detect module comprises:
a face detect module for detecting faces of the plurality of subjects;
an eye detect module for detecting respective eyes of the plurality of subjects; and
a blinked eye detect module for detecting at least one blinked eye artifact from
the eyes of the plurality of subjects.

19. The system of claim 18, wherein the detect module further comprises a classification module for classifying a degree of closing for each one of the eyes of the plurality of subjects.

20. The system of claim 15, further comprising a database for storing the open eye images of the plurality of subjects.
